(19) United States
(12) Patent Application Publication
(10) Pub. No.: US 2007/0214786 A1
(43) Pub. Date: Sep. 20, 2007

(54) Internal combustion engine and method of operating the engine

(76) Inventors: Stephan Arndt, Eschenbach (DE); Igor Gruden, Leonberg (DE); Admir Kreso, Canton, MI (US); Michael Onischke, Tiefenbronn (DE)

Correspondence Address: KLAUS J. BACH, 4407 TWIN OAKS DRIVE, MURRYSVILLE, PA, 15668, US

(21) Appl. No.: 11/378,809

(22) Filed: Mar. 20, 2006

(51) Int. Cl. F02D 23/00; F02B 33/44

(52) U.S. Cl. 60/600; 60/605.1; 60/607; 60/608

(57) ABSTRACT

In an internal combustion engine with a crankshaft and an exhaust gas duct including an exhaust gas power turbine which is coupled to the crankshaft via a variable transmission, a control unit is provided for controlling the transmission ratio of the variable transmission such that the speed of the turbine is adapted to the flow speed of the exhaust gas through the turbine in such a way that the turbine is always operated in an optimal efficiency range.

### BACKGROUND OF THE INVENTION

The invention relates to an internal combustion engine including an exhaust gas turbine connected, via a power transmission, to the crankshaft of the internal combustion engine, and to a method of operating such an engine.

DE 103 55 563 A1 discloses an internal combustion engine with an exhaust gas turbine which is integrated into the exhaust duct of the engine and in which the exhaust gas flow of the internal combustion engine is expanded. The exhaust gas turbine is coupled to the crankshaft of the engine via a power transmission which may comprise a shift transmission or an infinitely variable transmission. The internal combustion engine know from DE 103 55 563 already has a high efficiency, however, the exhaust turbine integrated into the exhaust duct and coupled to the crankshaft via a power transmission is not operable at optimal efficiency under all operating conditions so that there is a need for optimizing the efficiency of the arrangement.

It is therefore the object of the present invention to provide a further optimized internal combustion engine of this type and a method of operating such an engine.

### SUMMARY OF THE INVENTION

In an internal combustion engine with a crankshaft and an exhaust gas duct including an exhaust gas turbine which is coupled to the crankshaft via a variable transmission, a control unit is provided for controlling the transmission ratio of the variable transmission such that the speed of the turbine is adapted to the flow speed of the exhaust gas through the turbine in such a way that the turbine is operated at optimal efficiency.

In this way, the turbine can operate at optimized efficiency at practically all operating points of the internal combustion engine so that the overall efficiency of the internal combustion engine can be improved over the state of the art. The control unit automatically adjusts the transmission ratio of the transmission to an optimal setting such that an efficiency-optimized ratio of the speed of the turbine coupled to the crankshaft via the transmission and the flow speed of the exhaust gas through the turbine is obtained.

The invention also resides in a method of operating an internal combustion engine with an exhaust gas turbine coupled to the crankshaft of the engine with such an adjustable transmission ratio transmission for optimized efficiency.

Preferred embodiments of the invention will become more readily apparent from the following description thereof on the basis of the accompanying drawings.

### BRIEF DESCRIPTION OF THE DRAWINGS

FIG. 1 shows schematically a first embodiment of an internal combustion engine with an exhaust gas turbine arrangement according to the invention,

FIG. 2 shows schematically a second embodiment of an internal combustion engine with an exhaust gas turbine connected to the crankshaft,

FIG. 3 show schematically a third embodiment of an internal combustion engine with an exhaust gas turbine connected to the crankshaft,

FIG. 4 shows schematically a fourth embodiment of an internal combustion engine with an exhaust gas turbine connected to the crankshaft,

FIG. 5 shows schematically a fifth embodiment of an internal combustion engine with an exhaust gas turbine connected to the crankshaft,

FIG. 6 shows schematically a sixth embodiment of an internal combustion engine with an exhaust gas turbine connected to the crankshaft,

FIG. 7 shows schematically a seventh embodiment of an internal combustion engine with an exhaust gas turbine connected to the crankshaft,

FIG. 8 shows schematically an eighth embodiment of an internal combustion engine with an exhaust gas turbine connected to the crankshaft, and

FIG. 9 shows a diagram for the explanation of the effects of the invention.

### DESCRIPTION OF THE VARIOUS EMBODIMENTS

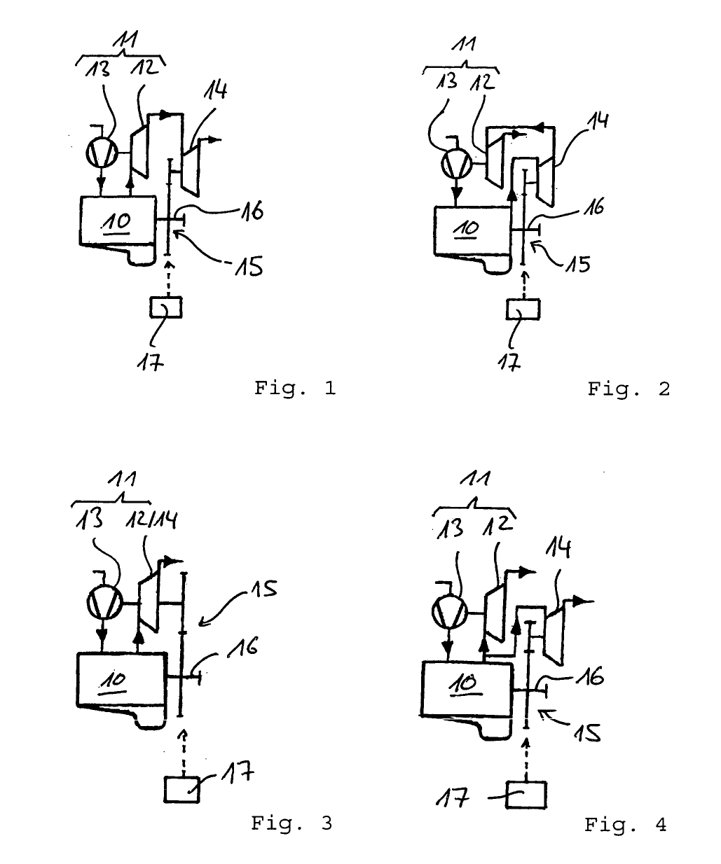

FIG. 1 shows, in a highly schematic representation, an internal combustion engine 10 with an exhaust gas turbocharger 11 which comprises a turbine 12 and a compressor 13. In the turbine 12, an exhaust gas leaving the internal combustion engine 10 is expanded and the mechanical power generated thereby is used to drive the compressor 13 which compresses the combustion air supplied to the internal combustion engine 10. The exhaust gas expanded in the turbine 12 of the exhaust gas turbocharger 11 is then supplied to another turbine 14, which is also integrated into the exhaust gas duct and which is coupled, by way of a power transmission 15 with the crankshaft 16 of the internal combustion engine. The other turbine 14 is also called a power turbine.

The efficiency of the power turbine 14 which is coupled to the crankshaft 16 by way of the transmission 15 depends, on one hand, on the flow speed of the exhaust gas through the turbine 14 and, on the other hand, on the speed of the turbine 14. Examinations have shown that such a turbine 14 is operated at optimal efficiency when a certain relationship is maintained between the flow speed of the exhaust gas through the turbine 14 and the rotational speed of the turbine.

FIG. 9 shows a diagram in which the efficiency E of the turbine 14 in % is plotted (vertical axis 20) over the ratio U/C that is the ratio of the speed U in rpm of the turbine 14 and the flow speed C of the exhaust gas through the turbine 14. The area 21 indicates the optimum operating efficiency range of the turbine. As shown in FIG. 9, the optimum efficiency range is in an U/C range of about 0.6 to 0.9, particularly between 0.65 and 0.85.

In accordance with the present invention, a control unit 17 is provided which automatically adjusts the transmission ratio of the power transmission 15 such that the turbine 14 is operated in the optimal range. The transmission 15 may be an automatically shifted shift transmission or an infinitely variable transmission.

For the automatic adaptation of the transmission ratio of the transmission 15 the control unit 17 preferably calculates the flow speed of the exhaust gas through the turbine 18 from the combustion air flow supplied to the internal combustion engine 10 and the fuel amount supplied to the internal combustion engine. If the internal combustion engine includes exhaust gas recirculation, the recirculation exhaust gas flow is taken into consideration for the calculation of the exhaust gas flow speed in addition to the combustion air flow and the fuel flow.

On the basis of the flow speed of the exhaust gas through the turbine 14 calculated in this way and the known speed of the crankshaft 16, the control unit 17 determines the transmission ratio of the respective transmission 15 in such a way that the turbine 14 has a speed which is optimized for the particular flow speed of the exhaust gas. In this way, it is ensured that the turbine 14 is always operated at an optimal speed with respect to the flow speed of the exhaust gases and consequently, is always operated at an optimal efficiency. An efficiency-optimized ratio of the speed (rpm) of the turbine 14 coupled to the crankshaft 16 by way of the transmission 15 and the flow speed of the exhaust gas through the turbine 14 is maintained in this way.

In the preferred embodiment of FIG. 1, the turbine 12 of the exhaust gas turbocharger 11 as well as the power turbine 14 coupled to the crankshaft via the transmission 15 are arranged in a series circuit wherein, in the flow direction of the exhaust gas the turbine 12 of the exhaust gas turbocharger 11 is disposed upstream of the power turbine 14 which is coupled to the crankshaft 16 by way of the transmission 15.

The invention is of course not limited to the arrangement as shown in FIG. 1, but can be used in an analog manner also in connection with other internal combustion engine arrangements as they are schematically shown in FIGS. 2 to 8. FIG. 2 for example shows an internal combustion engine wherein the turbine 12 of the exhaust gas turbocharger 11 and the power turbine 14 coupled to the crankshaft 16 are again interconnected in a series flow arrangement but, in flow direction of the exhaust gas, the turbine 12 of the exhaust gas turbocharger 11 is arranged upstream of the power turbine 14, which is coupled to the crankshaft 16 by way of the transmission 15. The inventive concept can be utilized of course also with such an internal combustion engine arrangement.

FIG. 3 shows a configuration of an internal combustion engine wherein the power turbine 14 coupled to the crankshaft 16 via the transmission 15 is at the same time the turbine 12 of the exhaust gas turbocharger 11. In contrast, in the embodiment of FIG. 4, the turbines 12 and 14 are separate components and connected in a parallel flow arrangement so that part of the exhaust gas flow discharged from the internal combustion engine 10 is supplied to the turbine 12 of the exhaust gas turbocharger 11 and another part of the exhaust gas flow is supplied to the power turbine 16 coupled to the crankshaft 16 via the transmission 15. Also in the embodiment of FIG. 5, the turbine 12 of the exhaust gas turbocharger 11 and the power turbine 14 coupled to the crankshaft 16 via the transmission 15 are arranged in a parallel flow arrangement wherein in the embodiment of FIG. 5, this parallel flow arrangement is realized in the form of a so-called pre-separation arrangement.

Also in the arrangements of FIGS. 3 to 5, the transmission ratio of the transmission 15 can be automatically controlled by the control unit 17 in accordance with the invention in such a way that the power turbine 14 is always operated with optimized efficiency by maintaining a predetermined ratio between the speed of the power turbine 14 and the flow speed of the exhaust gas through the power turbine 14.

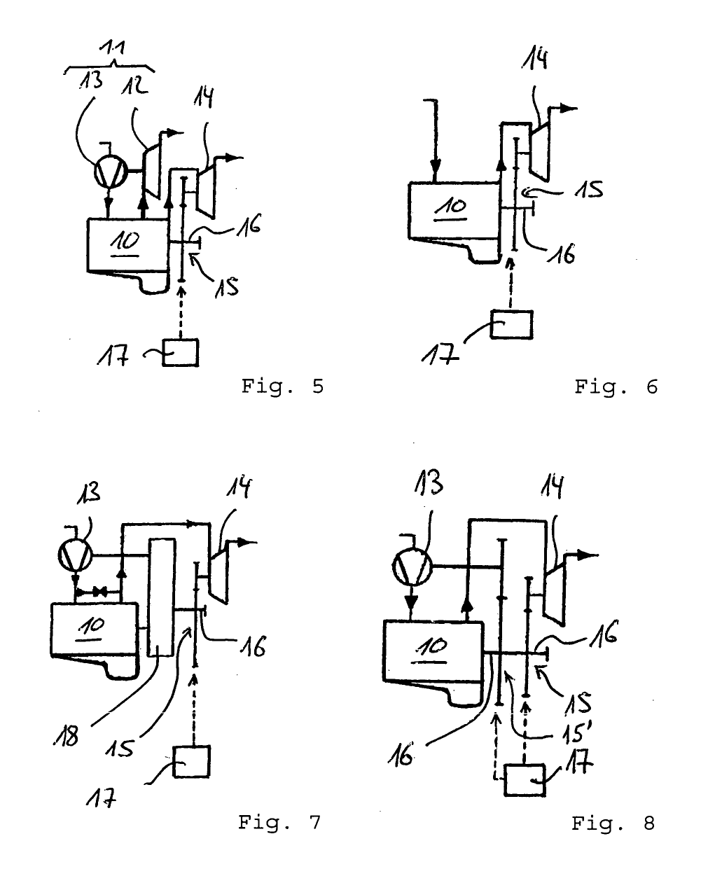

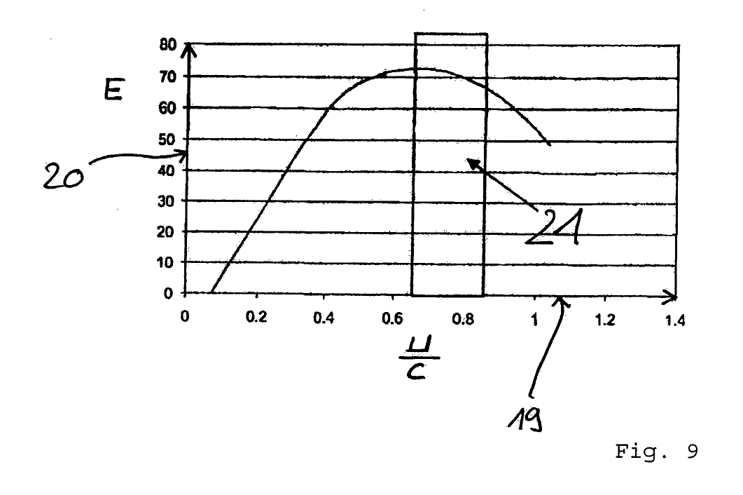

FIG. 6 shows an embodiment of an internal combustion engine without turbocharger that is a suction type internal combustion engine. FIG. 7 shows a configuration of an internal combustion engine with so-called differential charging wherein, between the transmission 15 via which the power turbine 14 is coupled to the crankshaft 16 and the internal combustion engine 10, a differential transmission 18 is arranged via which turbine power is supplied to the compressor 13. The internal combustion engine as shown in FIG. 8 operates in accordance with the so-called drive gas procedure wherein the turbine 14 is connected via the transmission 15, on one hand, to the crankshaft 16, and, on the other, to the compressor 13 via another transmission 15′ which may also be a shift or infinitely variable transmission in order to be capable of operating the compressor 13 at high speed even when the engine 10 is idling or operating at low speeds.

Also in the embodiments of FIGS. 6 to 8, the transmission ratio of the transmission 15 can be automatically so controlled by the control unit 17 that a desired ratio between the speed of the turbine 14 and the flow speed of the exhaust gas through the turbine 14 is maintained so as to operate the turbine 14 with optimized efficiency.

In each of the embodiments of FIGS. 1-8, a single power turbine 14 is coupled to the crankshaft 16 via a transmission 15. It is however noted that the invention is also applicable if several power turbines 14 are coupled to the crankshaft, each by a variable transmission 15.

The power turbine 14 which is coupled to the crankshaft 16 via the transmission 15 may have a variable turbine geometry that is it may have an adjustable inlet vane structure. The variable turbine geometry may include a radial guide vane structure with pivotable vanes or an axially movable guide vane structure. The use of a turbine with a variable turbine geometry has the advantage that the pressure difference in the turbine 14 can be adjusted while the optimum ratio between the flow speed of the exhaust gas through the turbine 14 and the speed of the turbine can be maintained. A turbine with a variable turbine geometry can be used in connection with a step-shift transmission or an infinitely variable automatic transmission 15.

If several power turbines 14 are each coupled to the crankshaft 16 by a transmission 15, the control unit 17 adjusts the transmission ratio of each transmission 15 in such a way that the efficiency-optimized ratio between the speed of the respective turbine 14 and the exhaust gas flow speed through the respective turbine 14 is maintained.

The invention is preferably used in connection with Diesel engines in commercial vehicles. However, the invention is not limited to this particular application; rather, the invention may just as well be used in connection with Diesel internal combustion engines for passenger cars and also in connection with gasoline internal combustion engines.

What is claimed is:

1. An internal combustion engine (10) having a crankshaft (16) and at least one exhaust duct for the discharge of exhaust gases from the engine and an exhaust gas power turbine (14) arranged in an exhaust duct and being coupled with the crankshaft (16) via a variable transmission (15), and a control unit (17) for controlling the transmission ratio of the variable transmission such that the speed of the power turbine (14) which is coupled to the crankshaft (16) via the transmission (15) is adapted to a flow speed of the exhaust gas through the power turbine (14) so that the turbine is operated at optimal efficiency.

2. An internal combustion engine as claimed in claim 1, wherein the control device (17) is programmed to automatically adapt the transmission ratio of the transmission (15) so as to provide for an efficiency-optimized ratio of the speed (rpm) of the power turbine (14) and the flow speed of the exhaust gas through the power turbine (14).

3. An internal combustion engine as claimed in claim 1, wherein the control unit (17) includes means for calculating the flow speed of the exhaust gases in the turbine (14) from the combustion air flow and the fuel flow injected into the combustion air, taking into consideration any re-circulated exhaust gas flow volume.

4. An internal combustion engine as claimed in claim 1, wherein the control unit (17) controls the transmission ratio of the transmission (15) on the basis of the flow speed of the exhaust gas in the power turbine (14) and the speed of the crankshaft automatically in such a way that the power turbine (14) has a speed optimized on the basis of the flow speed of the exhaust gas.

5. An internal combustion engine as claimed in claim 1, wherein the transmission (15) is an automatic infinitely variable transmission.

6. An internal combustion engine as claimed in claim 1, wherein the transmission (15) is an automatic shift transmission.

7. An internal combustion engine as claimed in claim 1, wherein the internal combustion engine (10) includes an exhaust gas turbocharger (11) with a compressor (13) and an exhaust gas turbine (12) and the power turbine (14) which is coupled with the crankshaft (16) via a transmission (15) and the exhaust gas turbine (12) of the turbocharger are arranged in an exhaust gas flow circuit in one of a series and a parallel flow arrangement.

8. An internal combustion engine as claimed in claim 1, wherein the power turbine (14) has a variable inlet geometry.

9. A method of operating an internal combustion engine (10) having a crankshaft (16) and at least one exhaust duct with an exhaust gas turbine (14) disposed in the exhaust duct and being coupled to the crankshaft (16) of the engine (10) via a transmission 915), said method comprising the steps of adapting the transmission ratio of the transmission (15) in such a way that the power turbine (14) coupled to the crankshaft (16) is adapted to the flow speed of the exhaust gas through the power turbine (14) so that the power turbine (14) is operated at an optimized efficiency.

10. A method according to claim 9, wherein the flow speed of the exhaust gas in the power turbine (14) is calculated from an available combustion air flow value and an available fuel volume flow taking into consideration any re-circulated exhaust gas flow volume.

11. A method according to claim 9, wherein the transmission ratio of the transmission (15) is adjusted on the basis of the exhaust gas flow speed in the power turbine (14) and the speed of the crankshaft (16) so that the power turbine (14) has a speed which is optimal, based on the flow speed of the exhaust gas in the turbine (14).
